(19) United States
(12) Patent Application Publication
(10) Pub. No.: US 2024/0199908 A1
(43) Pub. Date: Jun. 20, 2024

(54) HYBRID COATING UTILIZING EPOXY RESIN AND MONOMERS CAPABLE OF UNDERGOING RING OPENING METATHESIS POLYMERIZATION THAT INCORPORATES TRICYCLOPENTADIENE

(71) Applicant: Advanced Polymer Coatings, Inc., Avon, OH (US)

(72) Inventor: Jeremy Pasatta, Olmsted Falls, OH (US)

(73) Assignee: Advanced Polymer Coatings, Inc., Avon, OH (US)

(21) Appl. No.: 18/544,832

(22) Filed: Dec. 19, 2023

Related U.S. Application Data
(60) Provisional application No. 63/433,553, filed on Dec. 19, 2022.
(60) Provisional application No. 63/433,552, filed on Dec. 19, 2022.
(60) Provisional application No. 63/446,401, filed on Feb. 17, 2023.

(51) Int. Cl. C09D 151/08

(52) U.S. Cl. CPC C09D 151/08

(57) ABSTRACT

A coating composition includes an epoxy resin, tricyclopentadiene and optionally other monomers capable of undergoing ring opening metathesis polymerization, an amine curative, and a metathesis catalyst. A coating process includes forming the coating composition, depositing the coating composition on a substrate, evaporating a solvent from the deposited coating composition, and curing the coating composition. An article includes a substrate and a coating layer formed from the coating composition. Advantageously, the coating layer surface does not include tricyclopentadiene crystals.

This application claims priority to U.S. Provisional Application Ser. No. 63/433,552 filed Dec. 19, 2022, U.S. Provisional Application Ser. No. 63/433,553 filed Dec. 19, 2022, and U.S. Provisional Application Ser. No. 63/446,401 filed Feb. 17, 2023, the contents of which are incorporated by reference herein.

### BACKGROUND

The present exemplary embodiment relates to a hybrid coating composition containing both epoxy resin and monomers capable of undergoing ring opening metathesis polymerization. Curing may be at ambient temperature using both an amine curative and ruthenium-based Grubbs' catalyst. The hybrid coating contains both dicyclopentadiene and tricyclopentadiene, and has a reactivity such that tricyclopentadiene (TCPD) is sufficiently incorporated into the polyolefin polymer such that it does not form TCPD crystals on the surface of the coating after curing.

It would be desirable to develop new coatings that exhibit high flexibility and gloss, good adhesion and excellent chemical resistance while curing at ambient temperature in a short amount of time and shows compatibility between epoxy resin and monomers capable of undergoing ring opening metathesis polymerization. Incorporation of TCPD into the polyolefin polymer increases properties such as glass transition temperature, but if the TCPD is not fully polymerized in the polyolefin polymer, it will become incompatible after the coating cures and will produce TCPD crystals on the surface of the coating. Not only does this decrease the properties of the polyolefin portion of the coating, but the crystals will need to be removed from the surface of the coating, which can cause cleaning and contamination issues.

### BRIEF DESCRIPTION

A coating composition contains an epoxy resin, monomers capable of undergoing ring opening metathesis polymerization, an amine curative (e.g., a polyamide-based curative), and a metathesis catalyst (e.g., a ruthenium-based Grubbs' catalyst). The composition may further contain a solvent, a filler, and one or more other additives.

The coating composition may contain any epoxy resin capable of undergoing polymerization with but not limited to an amine-based catalyst. A preferred epoxy resin is a novolac epoxy resin of functionality greater than 2.

Furthermore, the coating composition will contain monomers capable of undergoing ring opening metathesis polymerization. The monomers may include one or more cyclic olefins. Preferred examples include but are not limited to dicyclopentadiene and tricyclopentadiene, norbornene and functional norbornene monomers.

Furthermore, the coating may contain a solvent that exhibits solubility for both the epoxy resin and the monomer capable of undergoing ring opening metathesis polymerization. Examples of such solvents include but are not limited to aromatic solvents such as xylene, toluene and Solvent 150 or glycol ether-based solvent such as Dowonal DPM.

Furthermore, the coating will contain an amine curing agent that does not decrease the efficiency of the ring opening methathesis catalyst, and also increases the compatibility between the epoxy resin and monomer capable of undergoing ring opening metathesis polymerization. Examples include but are not limited to polyamide curing agents and phenalkamine curing agents.

Furthermore, the coating composition may contain a filler. Examples include but are not limited to silica (e.g., crystalline silica), barium sulfate and wollastonite. Other non-limiting examples of fillers include alumina, silicates, talc, aluminosilicates, mica, diatomite, calcium carbonate, calcium sulfate, aluminum hydroxide, magnesium hydroxide, zinc oxide, and carbon black.

Furthermore, the coating composition may contain a rheology modifier. Examples include but are not limited to hydrophobic fumed silica.

Furthermore, the coating may contain additional additives such as adhesion promoters and flow and levelling additives.

The coating may be capable of curing at room temperature in less than 12 hours. Alternatively, the coating can be additionally cured with heat to improve properties.

Further disclosed are processes for applying a coating. The processes include depositing a coating composition containing the composition described, evaporating the solvent, and curing the epoxy resin.

These and other non-limiting characteristics are more particularly described below.

### BRIEF DESCRIPTION OF THE DRAWINGS

FIG. 1 is a flow chart illustrating a non-limiting example of a coating process in accordance with some embodiments of the present disclosure.

FIG. 2 is a side cross-sectional view of a coated article in accordance with some embodiments of the present disclosure.

### DETAILED DESCRIPTION

The present disclosure may be understood more readily by reference to the following detailed description of desired embodiments included therein. In the following specification and the claims which follow, reference will be made to a number of terms which shall be defined to have the following meanings.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent can be used in practice or testing of the present disclosure. All publications, patent applications, patents, and other references mentioned herein are incorporated by reference in their entirety. The materials, methods, and articles disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases that require the presence of the named ingredients/steps and permit the presence of other ingredients/steps.

However, such description should be construed as also describing compositions, mixtures, or processes as “consisting of” and “consisting essentially of” the enumerated ingredients/steps, which allows the presence of only the named ingredients/steps, along with any impurities that might result therefrom, and excludes other ingredients/steps.

Unless indicated to the contrary, the numerical values in the specification should be understood to include numerical values which are the same when reduced to the same number of significant figures and numerical values which differ from the stated value by less than the experimental error of the conventional measurement technique of the type used to determine the particular value.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The present disclosure relates to a coating composition containing an epoxy resin, monomers capable of undergoing ring opening metathesis polymerization, an amine curative, and a catalyst capable of initiating ring opening metathesis polymerization.

The coating composition is capable of a dual cure mechanism, in which the epoxy is cured by an amine hardener, and the monomers capable of undergoing ring opening metathesis polymerization are cured by a suitable initiator, such as a ruthenium-based Grubbs' catalyst. The combination of the two resin systems allows for a hybrid coating that combines the benefits of each technology. Amine-cured epoxy-based coatings give excellent mechanical properties, good chemical resistance and adhesion to substrates, but tend to be poor in flexibility and do not have a high degree of hydrophobicity. Coatings prepared from ring opening metathesis polymerization contain excellent flexibility and good hydrophobicity but tend to have inferior chemical resistance to epoxies and have poor adhesion to substrates. By combining the two cure mechanisms, advantageous properties of both systems can be realized in one coating, giving a coating that has high chemical resistance, good adhesion, high flexibility and hydrophobicity and excellent mechanical properties. Formulation components may be selected to provide a successful formulation. Epoxy resin and monomers capable of undergoing ring opening metathesis polymerization are generally incompatible, and when mixed together in a coating composition will separate and give an inhomogeneous coating. The present coating formulation overcomes this issue by using a solvent that is capable of compatibilizing the epoxy resin and monomers capable of undergoing ring opening methathesis polymerization. Examples include aromatic solvents such as xylene, toluene and Solvent 150 as well as glycol ether-based solvents, such as Dowanol DPM. The solvent should be capable of being added at a level that is sufficient to compatibilize the coating formulation, but not high enough that it negatively impacts the overall percent solids of the formulation. Catalysts that are capable of initiating ring opening metathesis polymerization, such as Grubbs' catalyst, can be reduced in efficiency by reaction with amines. Therefore, the amine should be selected to avoid poisoning the Grubbs' catalyst. Furthermore, the amine may be capable of providing additional compatibility for the epoxy resin and monomers capable of undergoing ring opening metathesis polymerization. Examples of amines that accomplish both objectives include formulated polyamide curing agents and phenalkamine curing agents. The amine curing agent should also give dry times less than 12 hours for applications that require fast return to service. When combined with the Grubbs' catalyst, a coating composition that gives good dry times is achievable. The coating composition will also contain a high degree of filler to reduce overall coating cost and improve coating properties. These fillers are commonly known in the industry and examples include but are not limited to silica, barium sulfate and wollastonite. The formulation may also include other coating additives such as fumed silica, adhesion promoters and flow and levelling agents. Coatings made from only monomers capable of undergoing ring opening metathesis polymerization have very short working life, typically on the order of 5 to 15 minutes, which does not make this technology suitable for coatings that are applied via airless spray, which require working times of 30 minutes or more. By combining the two curing technologies, working times of greater than 30 minutes are achieved along with viscosity suitable for airless spray applied coatings. The coating should also be formulated in a way that does not allow components to react, does not poison catalysts, and also limits the number of components that need to be mixed together. In order to achieve this, the Grubbs' catalyst should be combined in one component of the formulation, and the monomers capable of undergoing ring opening metathesis polymerization should be combined with the amine catalyst of the formulation. By separating the amine and the Grubbs' catalyst, the activity of the Grubbs' catalyst is maintained, and the formulation is limited to only two components that need to be mixed together before application.

Monomers capable of undergoing ring opening metathesis polymerization include but are not limited to dicyclopentadiene (DCPD) and tricyclopentadiene (TCPD). TCPD is a solid with a melting point of 62-64° C. If TCPD is not sufficiently polymerized into the polyolefin portion of the polymer, it will remain as a crystal in the coating, which can come to the surface of the coating after some period of time. The Tg of the resulting coating will be lower than if the TCPD was not incorporated. Also, the TCPD crystals must be cleaned from the coating, which will cause time and expense to the applicator. If coating is used as an internal tank lining to store or transport chemicals, and TCPD crystals are present, the TCPD crystals could potentially contaminate the chemical being stored or transported. The activity of the Grubb's catalyst should be sufficient such that TCPD is incorporated into the coating before the epoxy reaction with the amine prevents the TCPD from polymerizing. The overall composition of the coating should also be such that if there are minor amounts of TCPD that are not polymerized, the TCPD has sufficient solubility in the coating that it will not migrate to the surface of the coating once the coating is cured. Also, the concentration of TCPD can be minimized such that it is completely polymerized into the polyolefin polymer.

The coating composition may be provided in two parts, A and B. Providing the composition in parts A and B may have advantages such as avoiding premature reactions. Non-limiting examples of compositions for parts A and B are provided in Tables 1 and 2 below.

TABLE 1
Non-Limiting Examples for Part A

| | | Broad | Intermediate | Narrow |
|---|---|---|---|---|
| Component | Example | (wt %) | (wt %) | (wt %) |
| Solvent | Aromatic 150¹ | 0-30 | 3-20 | 5-15 |
| Metathesis | EXP-2020B² | 0.01-5 | 0.1-2 | 0.25-0.75 |
| Catalyst | | | | |
| Epoxy Resin | Epotec | 20-50 | 25-45 | 30-40 |
| | YDF-173³ | | | |
| Filler | Cimbar XF⁴ | 30-70 | 40-60 | 45-55 |
| Adhesion | Silquest | 0-5 | 0.01-2 | 0.1-0.7 |
| Promoter | A-187⁵ | | | |
| Pigment | TR90 TiO₂⁶ | 0-5 | 0.01-2 | 0.1-0.7 |
| Rheology | Aerosil | 0-5 | 0.5-3 | 1.5-2 |
| Modifier | R202⁷ | | | |
| Pigment | Nubifier | 0-5 | 0.5-3 | 1-1.5 |
| | R-5531⁸ | | | |

¹ExxonMobil Corporation
²Materia, Inc.
³Aditya Birla Group
⁴Cimbar Performance Minerals
⁵Momentive Performance Materials
⁶Venator Materials PLC
⁷Evonik Industries
⁸Ferro Corporation

TABLE 2
Non-Limiting Examples for Part B

| | | Broad | Intermediate | Narrow |
|---|---|---|---|---|
| Component | Example | (wt %) | (wt %) | (wt %) |
| Amine Curing | Ancamide | 20-70 | 30-60 | 40-50 |
| Agent | 2353⁹ | | | |
| Monomers | EXP-1961-NI¹⁰ | 10-60 | 20-50 | 30-40 |
| Capable of | | | | |
| Undergoing | | | | |
| Ring Opening | | | | |
| Metathesis | | | | |
| Polymerization | | | | |
| Filler | Cimbar XF¹¹ | 0-30 | 10-25 | 15-20 |
| Rheology | Aerosil R202¹² | 0-10 | 1-7 | 2-5 |
| Modifier | | | | |

⁹Evonik Industries
¹⁰Materia, Inc.
¹¹Cimbar Performance Minerals
¹²Evonik Industries

Ratio of A:B will depend on the amine and epoxy used, this will dictate stoichiometry. A:B ratio can also depend on filler and solvent level. In some embodiments, the stoichiometric range of epoxy to amine is in a range of about 0.8 to about 1.2, including from about 0.9 to about 1.1 and about 0.95 to about 1.05. The formulation may be done at a stoichiometry of 1.0.

It should be understood that parts A and B are not limited to the specific materials or types of materials discussed above. Moreover, various additives may be moved from part A to part B and vice versa. However, in general, the metathesis catalyst and the monomers capable of undergoing ring opening metathesis polymerization are provided in separate parts. Similarly, the epoxy resin and the amine curative are provided in separate parts. Moreover, the amine and the metathesis catalyst can be provided in separate parts to avoid the amine poisoning the metathesis catalyst. When parts A and B both contain an additive of a certain type, the specific additive in parts A and B may be

the same or different. Parts A and B may be provided separately in a kit that is shelf-stable. In some embodiments, the kit has a size in the range of one quart to 5 gallons.

Non-limiting examples of metathesis catalysts are disclosed in U.S. Pat. Nos. 5,728,917, 5,831,108, 7,132,503, and 7,294,717; and U.S. Pat. Pub. Nos. 2020/0362273 and 2022/0162351. The contents of these patents and publications are incorporated by reference herein in their entireties.

Some additional non-limiting examples of ring opening metathesis polymerization catalysts include [1,3-Bis-(2,4,6-trimethylphenyl)-2-imidazolidinylidene]dichloro(2-isopropoxybenzylidene)ruthenium(II) (CAS No. 301224-40-8); dichloro(benzylidene)bis(tricyclohexylphosphine)ruthenium(II) (CAS No. 172222-30-9); [1,3-Bis(2,4,6-trimethylphenyl)-2-imidazolidinylidene]-[2-[[(2-methylphenyl)imino]methyl]-phenolyl]-[3-phenyl-1H-inden-1-ylidene](chloro)ruthenium(II) (CAS No. 934538-12-2); Bis[1,3-bis(2,4,6-trimethylphenyl)-2-imidazolidinylidene]dichloro(3-phenyl-1H-inden-1-ylidene)ruthenium(II) (CAS No. 1383684-54-5); Dichlorobis(isobutylphobane)(3-phenyl-1H-indenylidene)ruthenium(II) (CAS No. 894423-99-5); [1,3-Bis(2,4,6-trimethylphenyl)-2-imidazolidinylidene]dichloro(benzylidene)(tricyclohexylphosphine)ruthenium(II) (CAS No. 246047-72-3); [1,3-Bis(2,4,6-trimethylphenyl)-2-imidazolidinylidene]dichloro(3-methyl-2-butenylidene)(tricyclohexylphosphine)ruthenium(II) (CAS No. 253688-91-4); [1,3-Bis(2,4,6-trimethylphenyl)-2-imidazolidinylidene]dichloro(3-phenyl-1H-inden-1-ylidene)(pyridyl)ruthenium(II) (CAS No. 1031262-76-6); [1,3-Bis(2,4,6-trimethylphenyl)-2-imidazolidinylidene]dichloro(3-phenyl-1H-inden-1-ylidene)(triphenylphosphine)ruthenium(II) (CAS No. 340810-50-6); Dichloro(2-isopropoxybenzylidene)(tricyclohexylphosphine)ruthenium(II) (CAS No. 203714-71-0); [1,3-Bis-(2-tolyl)-2-imidazolidinylidene]dichloro(2-isopropoxybenzylidene)ruthenium(II) (CAS No. 927429-61-6); and [1,3-Bis(2,4,6-trimethylphenyl)-2-imidazolidinylidene]dichloro(3-methyl-2-butenylidene)(tricyclohexylphosphine)ruthenium(II) (CAS No. 253688-91-4).

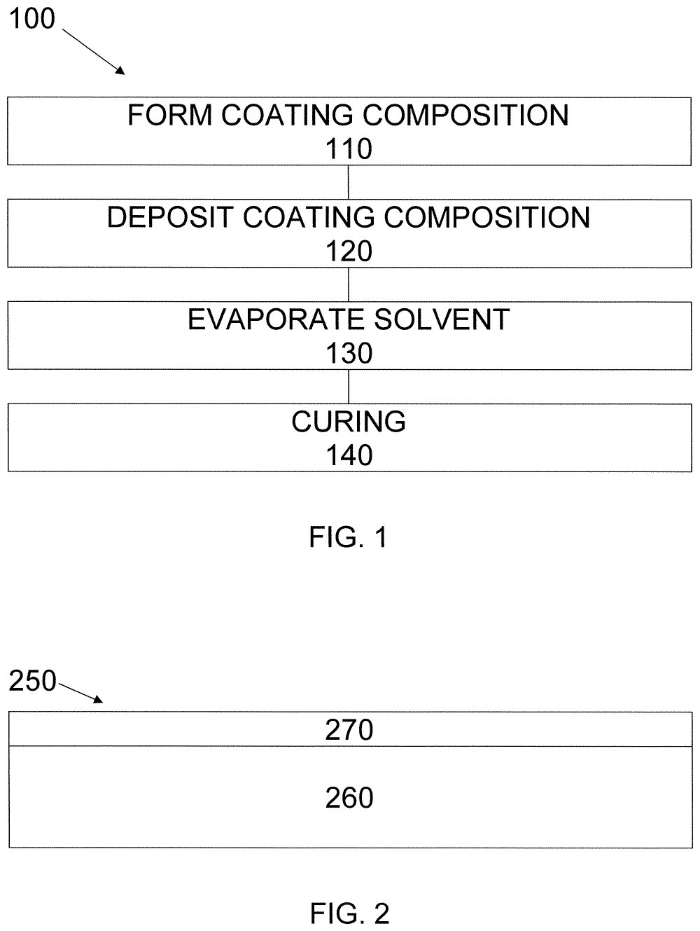

FIG. 1 is a flow chart illustrating a non-limiting example of a coating process 100 in accordance with some embodiments of the present disclosure. The process 100 includes forming a coating composition 110, depositing the coating composition on a substrate 120, evaporating a solvent (if present in the coating composition) 130, and curing the deposited coating composition 140.

In some embodiments, the coating composition is formed 110 by mixing a first part (A) and a second part (B).

The coating composition may be deposited 120 on the substrate using any suitable application step. In particular embodiments, airless spray application is used.

When the coating composition contains a solvent, the solvent may be partially or completely evaporated 130.

Curing 140 encompasses both the amine-curing of the epoxy resin and the ring opening metathesis polymerization.

It should be noted that one or more steps may be repeated to form a coating with a desired thickness.

FIG. 2 is a side cross-sectional view of a coated article 250 in accordance with some embodiments of the present disclosure. The article includes a substrate 260 with a coating layer 270 deposited thereof. The substrate 260 may be a monolayer or a multilayer substrate. The substrate may contain at least one metal element and/or at least one metalloid element. Metal alloys are included herein. The metal(s) may be selected from Li, Be, Na, Mg, Al, K, Ca, Sc, Ti, V, Cr, Mn, Fe, Co, Ni, Cu, Zn, Ga, Rb, Sr, Y, Zr, Nb, Mo, Tc, Ru, Rh, Pd, Ag, Cd, In, Sn, Cs, Ba, La, Ce, Pr, Nd, Pm, Sm, Eu, Gd, Tb, Dy, Ho, Er, Tm, Yb, Lu, Hf, Ta, W, Re, Os, Ir, Pt, Au, TI, Pb, Bi, Po, Fr, Ra, Ac, Th, Pa, Np, Pu, Am, Cm, Bk, Cf, Es, Fm, Md, No, Lr, Rf, db, Sg, Bh, Hs, Mt, Ds, Rg, Cn, Nh, Fl, Mc, and Lv. The metalloid(s) may be selected from B, Si, Ge, As, Sb, and Te. The coating layer 270 is formed from the coating composition described herein and may be formed in a single coating or multiple coatings.

The following examples are provided to illustrate the devices and methods of the present disclosure. The examples are merely illustrative and are not intended to limit the disclosure to the materials, conditions, or process parameters set forth therein.

### EXAMPLES

### Example 1: Enhanced Coating Composition Containing Dual Curing Mechanisms

TABLE 3
PART A

| | AMOUNT |
|---|---|
| COMPONENT | (parts by weight) |
| Solvent 150 (Aromatic solvent) | 50 |
| EXP-2020B (High Activity Grubbs' catalyst) | 300 |
| Epotec YDF-173 (Phenolic epoxy resin) | 200 |
| Cimbar XF (Barium sulfate) | 300 |
| Silquest A-187 (Adhesion promoter) | 2.5 |
| Titanium dioxide (Pigment) | 2.5 |
| Aersoil R202 (Rheology modifier) | 10 |
| Iron Oxide (Pigment) | 7.5 |

Solvent 150, EXP-2020B and YDF-173 are combined in a suitable container equipped with a Cowles mixing blade. The components are stirred until homogeneous, approximately 5 minutes. The stirring rate is then increased and the Cimbar XF is slowly added, and this mixture is allowed to stir at high shear rates for 10-15 minutes. After this time, the adhesion promoter and titanium dioxide are added and allowed to stir at high shear rates for 2-3 minutes. The Aerosil R202 is then added and the mixture is allowed to stir at high shear rates for 10 minutes. Finally, the iron oxide is added and the mixture is stirred an additional 2-3 minutes.

TABLE 4
PART B

| | AMOUNT |
|---|---|
| COMPONENT | (parts by weight) |
| Ancamide 2353 (modified polyamide curing agent) | 133.3 |
| EXP-1961-NI (DCPD/TCPD monomers) | 100 |
| Cimbar XF (Barium sulfate) | 50 |
| Aersoil R202 (Rheology modifier) | 10 |

Ancamide 2353 and EXP-1961-NI are added to a mixing vessel equipped with a Cowles type mixing blade and allowed to mix until homogeneous. The Cimbar XF is then slowly added to the mixture a high shear rate and allowed to mix for 10 minutes. Finally, the Aerosil R202 is slowly added and allowed to mix at high shear rates for an additional 10 minutes.

Part A and Part B are then thoroughly combined to give a coating composition capable of being applied via airless spray with the following properties:

| | | |
|---|---|---|
| Gel time (Shyodu gel timer) | 306 | min |
| Sag resistance | 60 | mil+ |
| Dry time (circular dry time recorder) | 9 | hours |
| Tg of cured film (second heat by DSC) | 97° | C. |

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

1. A coating composition comprising:
an epoxy resin;
tricyclopentadiene and optionally other monomers capable of undergoing ring opening metathesis polymerization;
an amine curing agent; and
a metathesis catalyst.

2. The coating composition of claim 1, further comprising:
a solvent;
a filler;
an adhesion promoter;
a rheology modifier; and
a pigment.

3. A coating composition kit comprising:
(A) a first part comprising:
an epoxy resin; and
a metathesis catalyst; and
(B) a second part comprising:
tricyclopentadiene and optionally other monomers capable of undergoing ring opening metathesis polymerization; and
an amine curing agent.

4. The coating composition kit of claim 3, wherein the first part (A) further comprises:
a solvent; and
optionally at least one additive selected from the group consisting of fillers, adhesion promoters, rheology modifiers, and pigments.

5. The coating composition kit of claim 4, wherein the solvent comprises an aromatic hydrocarbon.

6. The coating composition kit of claim 3, wherein the second part (B) further comprises at least one additive selected from the group consisting of fillers and rheology modifiers.

7. The coating composition kit of claim 3, wherein the first part (A) comprises:
0.01 to 5 wt % of the metathesis catalyst;
20 to 50 wt % of the epoxy resin;
30 to 70 wt % of a filler;
0 to 30 wt % of a solvent;
0 to 5 wt % of an adhesion promoter;
0 to 5 wt % of a first pigment;
0 to 5 wt % of a second pigment; and
0 to 5 wt % of a rheology modifier.

8. The coating composition kit of claim 3, wherein the first part (A) comprises:
0.1 to 2 wt % of the metathesis catalyst;
25 to 45 wt % of the epoxy resin;
40 to 60 wt % of a filler;
3 to 20 wt % of a solvent;
0.01 to 2 wt % of an adhesion promoter;
0.01 to 2 wt % of a first pigment;
0.5 to 3 wt % of a second pigment; and
0.5 to 3 wt % of a rheology modifier.

9. The coating composition kit of claim 3, wherein the first part (A) comprises:
0.25 to 0.75 wt % of the metathesis catalyst;
30 to 40 wt % of the epoxy resin;
45 to 55 wt % of a filler;
5 to 15 wt % of a solvent;
0.1 to 0.7 wt % of an adhesion promoter;
0.1 to 0.7 wt % of a first pigment;
1 to 1.5 wt % of a second pigment; and
1.5 to 2 wt % of a rheology modifier.

10. The coating composition kit of claim 3, wherein the second part (B) comprises:
20 to 70 wt % of the amine curing agent;
10 to 60 wt % of the tricyclopentadiene and optionally other monomers capable of undergoing ring opening metathesis polymerization;
0 to 30 wt % of a filler;
0 to 10 wt % of a rheology modifier.

11. The coating composition kit of claim 3, wherein the second part (B) comprises:
30 to 60 wt % of the amine curing agent;
20 to 50 wt % of the tricyclopentadiene and optionally other monomers capable of undergoing ring opening metathesis polymerization;
10 to 25 wt % of a filler;
1 to 7 wt % of a rheology modifier.

12. The coating composition kit of claim 3, wherein the second part (B) comprises:
40 to 50 wt % of the amine curing agent;
30 to 40 wt % of the tricyclopentadiene and optionally other monomers capable of undergoing ring opening metathesis polymerization;
15 to 20 wt % of a filler;
2 to 5 wt % of a rheology modifier.

13. A coating process comprising:
forming a coating composition by mixing
(A) a first part comprising:
an epoxy resin; and
a metathesis catalyst; and
(B) a second part comprising:
tricyclopentadiene and optionally other monomers capable of undergoing ring opening metathesis polymerization; and
an amine curing agent;
depositing the coating composition onto a substrate; and
curing the coating composition to form a coating layer;
wherein a surface of the coating layer opposite the substrate does not comprise tricyclopentadiene crystals.

14. The coating process of claim 13, wherein at least one of the first part (A) and the second part (B) further comprises a solvent; and wherein the process further comprises:
evaporating the solvent after the depositing and before the curing.

15. The process of claim 13, wherein the depositing comprises airless spray deposition.

16. The coating process of claim 13, wherein the curing is performed at ambient temperature or at an elevated temperature to improve properties and/or increase curing rate.

17. A coated article formed by the process of claim 13.

18. The coating process of claim 13, wherein the solvent comprises an aromatic hydrocarbon.

19. The coating process of claim 13, wherein the first part (A) comprises:
0.01 to 5 wt % of the metathesis catalyst;
20 to 50 wt % of the epoxy resin;
30 to 70 wt % of a filler;
0 to 30 wt % of a solvent;
0 to 5 wt % of an adhesion promoter;
0 to 5 wt % of a first pigment;
0 to 5 wt % of a second pigment; and
0 to 5 wt % of a rheology modifier.

20. The coating process of claim 13, wherein the second part (B) comprises:
20 to 70 wt % of the amine curing agent;
10 to 60 wt % of the tricyclopentadiene and optionally other monomers capable of undergoing ring opening metathesis polymerization;
0 to 30 wt % of a filler; and
0 to 10 wt % of a rheology modifier.
